(19) United States
(12) Patent Application Publication
(10) Pub. No.: US 2026/0197486 A1
(43) Pub. Date: Jul. 9, 2026

(54) METHOD AND DEVICE FOR VIDEO CODING USING TEMPLATE MATCHING-BASED INTER PREDICTION

(71) Applicants: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(72) Inventors: Dong Gyu Sim, Seoul (KR); Min Hun Lee, Uijeongbu-si (KR); Sea Nae Park, Uijeongbu-si (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(21) Appl. No.: 19/134,527

(22) PCT Filed: Nov. 24, 2023
(86) PCT No.: PCT/KR2023/019151

§ 371 Date: May 30, 2025

(30) Foreign Application Priority Data
Dec. 1, 2022 (KR) 10-2022-0165720
Nov. 22, 2023 (KR) 10-2023-0162973

(51) Int. Cl. H04N 19/52; H04N 19/105; H04N 19/117; H04N 19/176; H04N 19/57

(52) U.S. Cl. CPC H04N 19/52; H04N 19/105; H04N 19/117; H04N 19/176; H04N 19/57

(57) ABSTRACT

A method and an apparatus for video coding using a template matching-based inter prediction. A video decoding device decodes a merge index of the current block and generates a motion vector candidate list that includes a preset number of motion vector candidates. The video decoding device performs an initial motion refinement on the motion vector candidates and reorders the motion vector candidates. The video decoding device selects motion information of the current block from the motion vector candidates by using the merge index and generates a prediction block of the current block by using a selected motion information. In performing the initial motion refinement or reordering the motion vector candidates comprises by using a template matching, the video decoding device applies filtering to block partition boundaries within a template region of the current block.

### CROSS-REFERENCE TO RELATED APPLICATIONS

This is a U.S. national stage of International Applications No. PCT/KR2023/019151, filed on Nov. 24, 2023, which claims priority to Korean Patent Application No. 10-2022-0165720 filed on Dec. 1, 2022, and Korean Patent Application No. 10-2023-0162973, filed on Nov. 22, 2023, the entire contents of each of which are incorporated herein by reference.

### TECHNICAL FIELD

The present disclosure relates to a video coding method and an apparatus using a template matching-based inter prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Beyond VVC, adaptive reordering of merge candidates (ARMC) reorders motion vector candidates in merge mode based on template matching. When applying ARMC, the decoder divides the merge candidates into multiple subgroups and reorders the merge candidates in each subgroup according to the template matching cost. Calculated as the template matching cost is the sum of absolute differences (SAD) between the samples in the template region of the current block and their corresponding reference samples. The template is composed of the samples in the neighboring reconstructed region of the current block. Beyond VVC, reordering is applied to regular merge mode, template matching merge mode, or affine merge mode. ARMC can be applied to regular merge mode based on the template regions of the current block and the reference blocks, as illustrated in FIG. 6. Alternatively, as shown in FIG. 7, ARMC may be applied to affine merge mode based on the template regions of the current block and the template regions of the subblocks of the reference block. To increase video coding efficiency and enhance video quality when predicting the current block, there is a need for a method of effectively performing a template matching-based inter prediction.

### SUMMARY

The present disclosure seeks to provide a video coding method and an apparatus that compensate for motion of the current block during inter prediction of the current block by performing initial refining of motion vector candidates, reordering of the motion vector candidates, and filtering on a template region.

At least one aspect of the present disclosure provides a method of reconstructing a current block by a video decoding apparatus. The method includes decoding a merge index of the current block from a bitstream. The method also includes generating a motion vector candidate list of the current block. The motion vector candidate list includes a preset number of motion vector candidates, and a motion vector candidate is a uni-directional motion vector or bi-directional motion vectors. The method also includes performing an initial motion refinement on the motion vector candidates. The method also includes reordering the motion vector candidates. The method also includes selecting motion information of the current block from the motion vector candidates by using the merge index. The method also includes generating a prediction block of the current block by using a selected motion information. In performing the initial motion refinement or reordering the motion vector candidates, the method includes, when using a template matching, applying filtering to block partition boundaries within a template region of the current block.

Another aspect of the present disclosure provides a method of encoding a current block by a video encoding apparatus. The method includes generating a motion vector candidate list of the current block. The motion vector candidate list includes a preset number of motion vector candidates, and a motion vector candidate is a uni-directional motion vector or bi-directional motion vectors. The method also includes performing an initial motion refinement on the motion vector candidates. The method also includes reordering the motion vector candidates. The method also includes determining a merge index indicative of one of the motion vector candidates. The method also includes selecting motion information of the current block from the motion vector candidates by using the merge index. The method also includes generating a prediction block of the current block by using a selected motion information. In performing the initial motion refinement or reordering the motion vector candidates, the method includes, when using a template matching, applying filtering to block partition boundaries within a template region of the current block.

Yet another aspect of the present disclosure provides a computer-readable recording medium storing a bitstream generated by a video encoding method. The video encoding method includes generating a motion vector candidate list of a current block. The motion vector candidate list includes a preset number of motion vector candidates, and a motion vector candidate is a uni-directional motion vector or bi-directional motion vectors. The video encoding method also includes performing an initial motion refinement on the motion vector candidates. The video encoding method also includes reordering the motion vector candidates. The video encoding method also includes determining a merge index indicative of one of the motion vector candidates. The video encoding method also includes selecting motion information of the current block from the motion vector candidates by using the merge index. The video encoding method also includes generating a prediction block of the current block by using a selected motion information. In performing the initial motion refinement or reordering the motion vector candidates, the video encoding method includes, when using a template matching, applying filtering to block partition boundaries within a template region of the current block.

As described above, the present disclosure provides a video coding method and an apparatus that compensate for motion of the current block during inter prediction of the current block by performing initial refining of motion vector candidates, reordering of the motion vector candidates, and filtering on a template region. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating template regions of the current block and reference block.

FIG. 7 is a diagram illustrating template regions of a current block and template regions of subblocks of a reference block.

FIG. 8 is a diagram illustrating a method of deriving constructed affine merge candidates for affine motion prediction.

FIG. 9 is a detailed block diagram of a portion of a video decoding apparatus, according to at least one embodiment of the present disclosure.

FIG. 10 is a diagram illustrating a motion vector refinement using template matching, according to at least one embodiment of the present disclosure.

FIG. 11 is a diagram illustrating a template adjacent to a subblock, according to at least one embodiment of the present disclosure.

FIG. 12 is a diagram illustrating a motion vector refinement using template matching, according to another embodiment of the present disclosure.

FIG. 13 is a diagram illustrating filtering on a template region, according to at least one embodiment of the present disclosure.

FIG. 14 is a diagram illustrating filtering on a template region, according to another embodiment of the present disclosure.

FIG. 15 is a diagram illustrating filtering on a template region, according to another embodiment of the present disclosure.

FIG. 16 is a flowchart of a method of encoding a current block by a video encoding apparatus, according to at least one embodiment of the present disclosure.

FIG. 17 is a flowchart of a method of reconstructing a current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

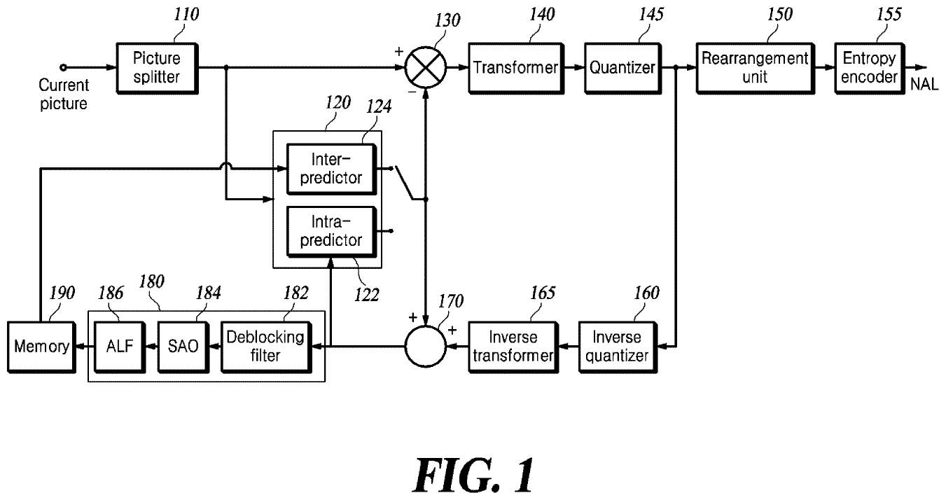

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

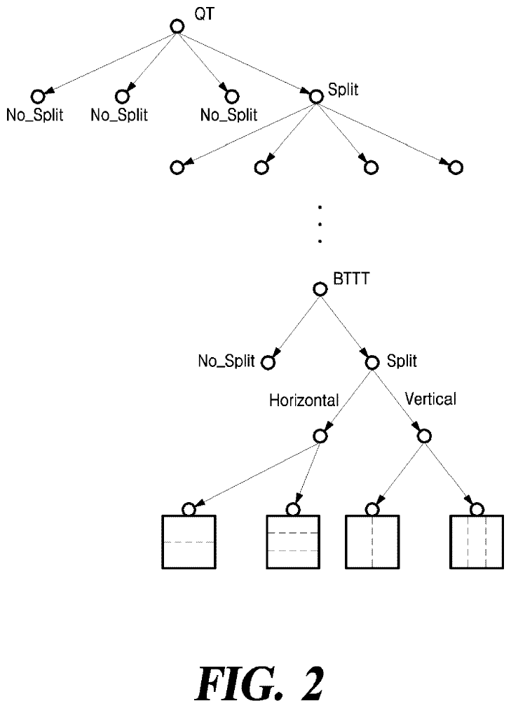

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

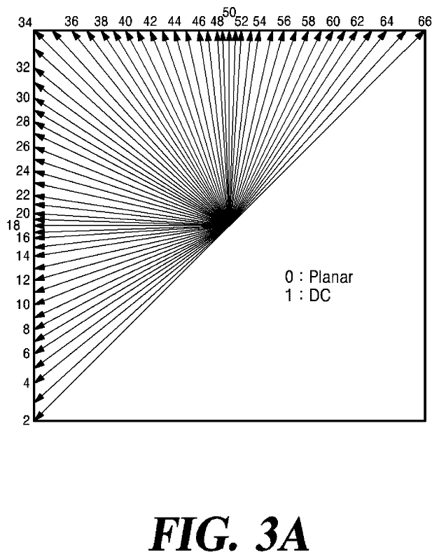

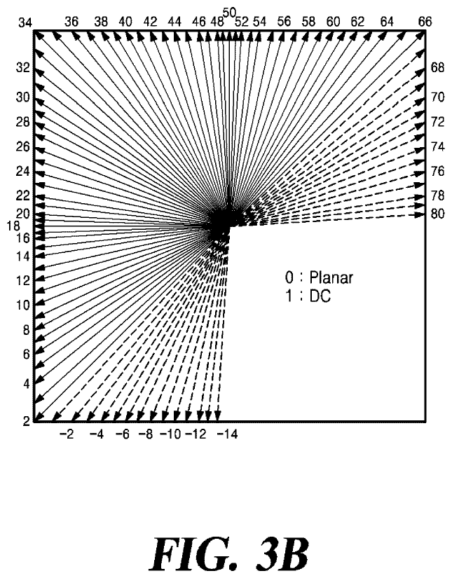

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

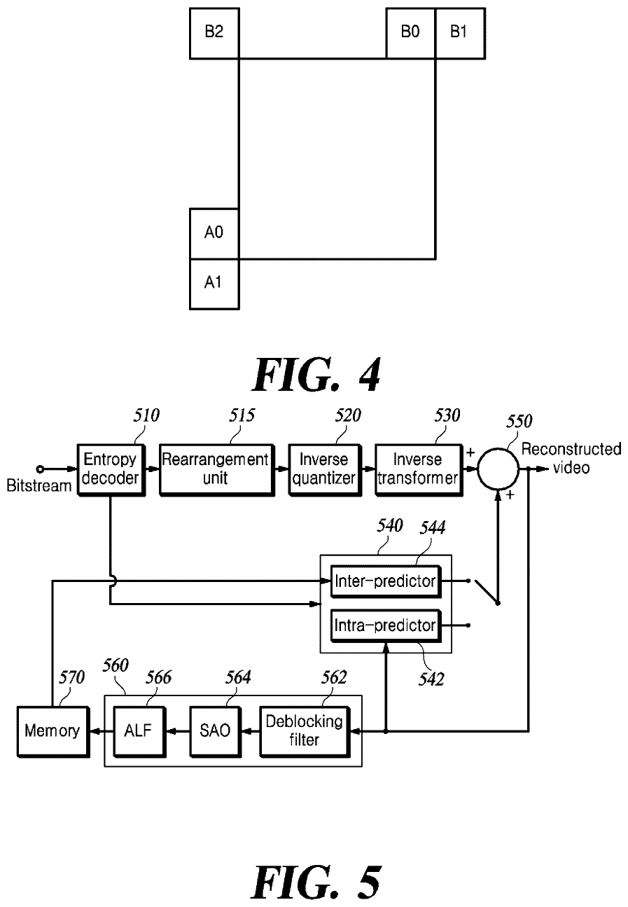

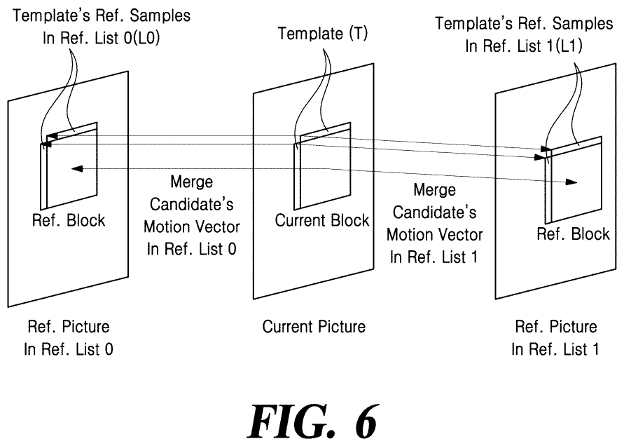

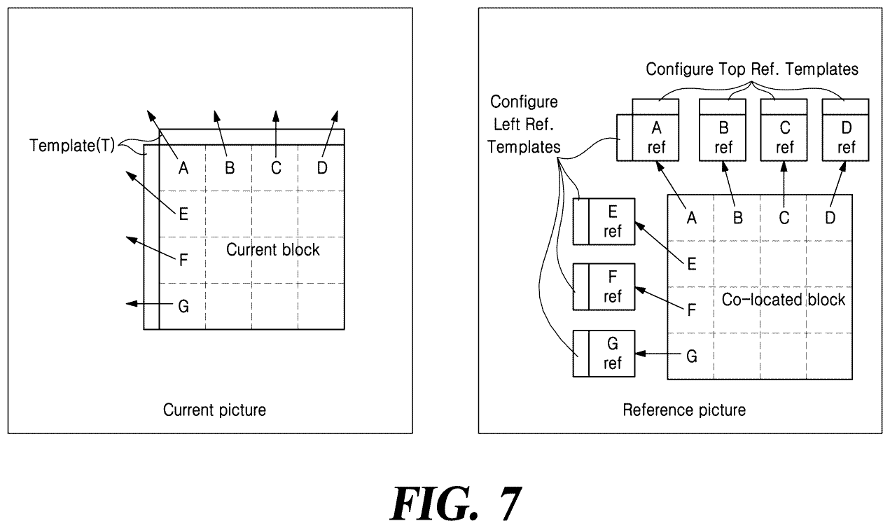

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that compensate for motion of the current block during inter prediction of the current block by performing initial refining of motion vector candidates, reordering of the motion vector candidates, and filtering on a template region.

The following embodiments may be performed by the inter predictor 124 in the video encoding device. The following embodiments may also be performed by inter predictor 544 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

The following describes inter prediction techniques related to merge mode.

### I-1. Merge/Skip Mode and MMVD

The merge/skip modes include regular merge mode, Merge mode with Motion Vector Difference mode (MMVD), geometric partitioning mode (GPM), and subblock merge mode. Here, the subblock merge mode is divided into Subblock-based Temporal Motion Vector Prediction (SbTMVP) mode and affine merge mode.

The following describes a method of composing a merge candidate list of motion information in a regular merge/skip mode. To support the merge/skip mode, the inter predictor 124 in the video encoding apparatus may select a preset number of (e.g., 6) merge candidates to form a merge candidate list.

The inter predictor 124 searches for spatial merge candidates. The inter predictor 124 searches for spatial merge candidates from neighbor blocks, as illustrated in FIG. 4. Up to four spatial merge candidates may be selected. The spatial merge candidates are also referred to as spatial MVPs (SMVPs).

The inter predictor 124 searches for temporal merge candidates. The inter predictor 124 may add as a temporal merge candidate a block that is co-located with the current block and located in a reference picture, other than the current picture holding the target block. Here, the reference picture may or may not be the same as the reference picture used to predict the current block. A single temporal merge candidate may be selected. A temporal merge candidate is also referred to as a temporal motion vector predictor candidate or temporal MVP (TMVP) candidate.

The inter predictor 124 searches for a History-based Motion Vector Predictor (HMVP) candidate. The inter predictor 124 may store the motion vectors of the previous h CUs in a table (where h is a natural number), and then may use the stored motion vectors as merge candidates. The size of the table is 6, and the inter predictor 124 stores the motion vectors of the previous CUs in a first-in first out (FIFO) manner. This indicates that up to six HMVP candidates are stored in the table. The inter predictor 124 may set the most recent motion vectors among the HMVP candidates stored in the table to be the merge candidates.

The inter predictor 124 searches for a pairwise average MVP (PAMVP) candidate. The inter predictor 124 may set the motion vector average of the first candidate and the second candidate in the merge candidate list to be the merge candidate.

If the merge candidate list cannot be filled up (i.e., fails to fulfill the preset number of merge candidates) after performing all of the above-mentioned search processes, the inter predictor 124 adds a zero motion vector as the merge candidate.

In terms of optimizing coding efficiency, the inter predictor 124 may determine a merge index that indicates one candidate in the merge candidate list. The inter predictor 124 may use the merge index to derive a motion vector predictor (MVP) from the merge candidate list, and then may determine the MVP as the motion vector of the current block. Further, the video encoding apparatus may signal the merge index to the video decoding apparatus.

The video encoding apparatus, when in the skip mode, utilizes the same motion vector transmission method as in the merge mode, but does not transmit a residual block corresponding to the difference between the current block and the prediction block.

The above-described method of composing the merge candidate list may be performed equally by the inter predictor 544 in the video decoding apparatus. The video decoding apparatus may decode the merge index. The inter predictor 544 may use the merge index to derive the MVP from the merge candidate list, and then determine the MVP to be the motion vector of the current block.

On the other hand, when utilizing the MMVD technique, the inter predictor 124 may utilize a merge index to derive an MVP from the merge candidate list. For example, the first or second candidate in the merge candidate list may be utilized as the MVP. Further, in terms of optimizing coding efficiency, the inter predictor 124 determines a distance index and a direction index. The inter predictor 124 may use the distance index and the direction index to derive a motion vector difference (MVD), and then may sum the MVD and the MVP to reconstruct the motion vector of the current block. Further, the video encoding apparatus may signal the merge index, the distance index, and the direction index to the video decoding apparatus.

The above-described MMVD technique may be equally performed by the inter predictor 544 in the video decoding apparatus. The video decoding apparatus may decode the merge index, the distance index, and the direction index. After the inter predictor 544 composes the merge candidate list, it may use the merge index to derive an MVP from the merge candidate list. After the inter predictor 544 derives the MVD by using the distance index and the direction index, it may sum the MVD and the MVP to reconstruct the motion vector of the current block.

### I-2. Affine Merge Mode

Inter prediction is a motion prediction that reflects a translational motion model, i.e., it predicts motion in the horizontal (x-axis direction) and vertical (y-axis direction). However, in practice, there may be various forms of motion other than translational motion, such as rotation, zoom-in or zoom-out. An affine motion prediction may reflect these different forms of motion.

There may be two types of models for affine motion prediction. One is a model that utilizes four parameters of two control point motion vectors (CPMVs), each being present at the top-left corner and the top-right corner of the target block to be encoded. The other model utilizes six parameters of three control point motion vectors, each being present at the top-left corner, top-right corner, and bottom-left corner of the target block.

The four-parameter affine model is represented as shown in Equation 1. The motion at a sample location (x,y) in the target block may be computed as shown in Equation 1. Here, the location of the top-left sample of the target block is assumed to be (0,0).

$$\{ \begin{matrix}m {v}_{x} = \frac{m {v}_{1 x} - m {v}_{0 x}}{W} x - \frac{m {v}_{1 y} - m {v}_{0 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix} \qquad [ Equation 1 ]$$

Further, the 6-parameter affine model is represented as shown in Equation 2. The motion at a sample location (x,y) in the target block may be computed as shown in Equation 2.

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad [ Equation 2 ]$$

Here, (mv₀ₓ,mv_{0y}) is the top-left corner control point motion vector, (mv₁ₓ,mv_{1y}) is the top-right corner control point motion vector, and (mv₂ₓ,mv_{2y}) is the bottom-left corner control point motion vector. W is the horizontal length of the target block and H is the vertical length of the target block.

The affine motion prediction may be performed for each sample in the target block by using a motion vector computed according to Equation 1 or Equation 2. Alternatively, to reduce the complexity of the computation, the affine motion prediction may be performed on a subblock-by-subblock basis, for example by partitioning the target block into subblocks of size 4×4.

The motion vector (mvₓ,mv_{y}) may be set to have a 1/16 sample precision. In this case, the motion vector (mvₓ,mv_{y}) calculated according to Equation 1 or 2 may be rounded to the 1/16 sample unit.

The video encoding apparatus performs intra prediction, inter prediction (translational motion prediction), affine motion prediction, and the like, and selects an optimal prediction method by calculating a rate-distortion (RD) cost. To perform affine motion prediction, the inter predictor 124 of the video encoding apparatus determines which of the two types of models is to be used, and determines two or three control points according to the determined type. The inter predictor 124 uses the control point motion vectors to compute the motion vector (mvₓ,mv_{y}) for each of the subblocks within the target block. Then, the motion vector (mvₓ,mv_{y}) of each subblock is used to perform motion compensation in the reference picture on a subblock-by-subblock basis to generate a prediction block for each subblock in the target block.

The video encoding apparatus encodes and passes to the video decoding apparatus affine-related syntax elements including a flag indicating whether affine motion prediction has been applied to the target block, type information indicating a type of affine model, and motion information indicating a motion vector of each control point. The type information and the motion information of the control points may be signaled when the affine motion prediction is performed, and the motion vectors of the control points may be signaled by the number of times determined by the type information.

The video decoding apparatus uses the signaled syntaxes to determine the type of the affine model and the control point motion vectors, and calculates the motion vector (mvₓ,mv_{y}) for each 4×4 subblock in the target block by using Equation 1 or 2. If the motion vector resolution information of the affine motion vector of the target block is signaled, the motion vector (mvₓ,mv_{y}) is modified by a precision identified by the motion vector resolution information by using an operation such as rounding.

The video decoding apparatus generates a prediction block of each subblock by performing motion compensation within the reference picture by using the motion vector (mvₓ,mv_{y}) for each subblock.

To reduce the amount of bits required to encode the control point motion vectors, the above-described regular method of inter prediction (translational motion prediction) may be applied.

In one example, when in the affine merge mode, the inter predictor 124 of the video encoding apparatus organizes a predefined number of (e.g., 5) affine merge candidate lists. First, the inter predictor 124 of the video encoding apparatus derives inherited affine merge candidates from the neighbor blocks of the target block. For example, by deriving a predefined number of inherited affine merge candidates from the neighboring samples A0, A1, B0, B1, and B2 of the target block shown in FIG. 4, a merge candidate list is generated. Each of the inherited affine merge candidates in the candidate list corresponds to a combination of two or three CPMVs (control point motion vectors).

The inter predictor 124 derives the inherited affine merge candidates from control point motion vectors of the target block's neighbor blocks that are predicted in affine mode. Some embodiments may limit the number of merge candidates derived from the neighbor blocks predicted in affine mode. For example, the inter predictor 124 may derive from the neighbor blocks predicted in affine mode, two inherited affine merge candidates, one of A0 and A1, and one of B0, B1, and B2. The prioritization may be in the order of A0, A1, and then the order of B0, B1, and B2.

On the other hand, if the total number of merge candidates is more than three, the inter predictor 124 may derive the required number of supplementary constructed affine merge candidates from the translational motion vectors of the neighbor blocks.

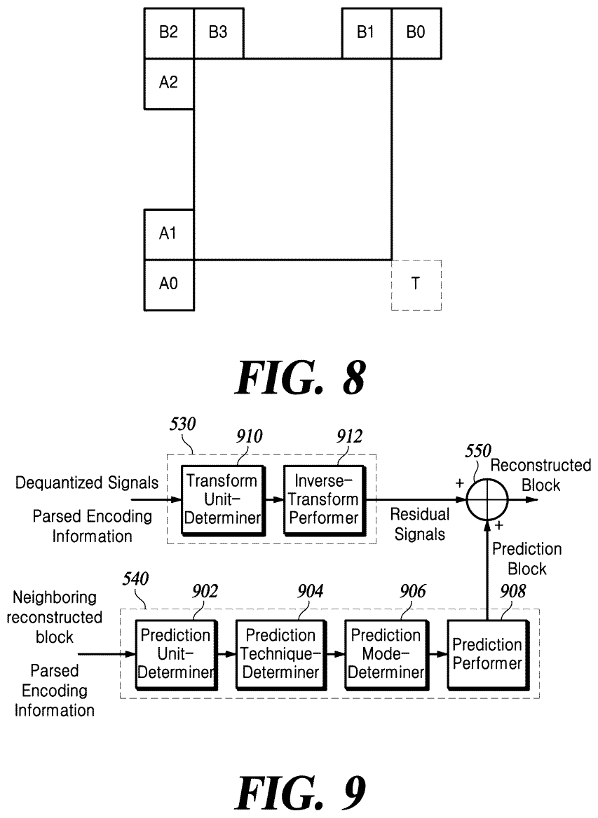

FIG. 8 is a diagram illustrating a method of deriving constructed affine merge candidates for affine motion prediction.

The inter predictor 124 derives control point motion vectors CPMV1, CPMV2, and CPMV3 each from each neighbor block in a group {B2, B3, A2}, each neighbor block in a group {B1, B0}, and each neighbor block in a group {A1, A0}. As one example, the prioritization within each neighbor block group may be in the order of B2, B3, and A2, the order of B1 and B0, and the order of A1 and A0. A further control point motion vector CPMV4 is derived from the co-located block T in the reference picture. The inter predictor 124 combines two or three control point motion vectors out of the four control point motion vectors to generate the required number of supplementary constructed affine merge candidates. The prioritization of the combinations is as follows. The elements within the respective groups are listed in the following order: control point motion vectors at the top-left corner, top-right corner, and then bottom-left corner.
{CPMV1, CPMV2, CPMV3}, {CPMV1, CPMV2, CPMV4}, {CPMV1, CPMV3, CPMV4}, {CPMV2, CPMV3, CPMV4}, {CPMV1, CPMV2}, {CPMV1, CPMV3}

If the merge candidate list cannot be filled up by using the inherited affine merge candidates and constructed affine merge candidates, the inter predictor 124 may add a zero motion vector as a candidate.

The inter predictor 124 selects a merge candidate from the merge candidate list in terms of optimizing coding efficiency, and determines a merge index that indicates the merge candidate. The inter predictor 124 uses the selected merge candidate to perform an affine motion prediction on the target block. When the merge candidate is composed of two control point motion vectors, an affine motion prediction is performed by using a four-parameter model. On the other hand, when the merge candidate is composed of three control point motion vectors, an affine motion prediction is performed by using a six-parameter model. The video encoding apparatus encodes and signals the merge index to the video decoding apparatus.

The video decoding apparatus decodes the merge index. The inter predictor 544 of the video decoding apparatus composes a merge candidate list in the same manner as the video encoding apparatus, and performs affine motion prediction by using control point motion vectors corresponding to the merge candidates indicated by the merge index.

### I-3. Geometric Partitioning Mode (GPM)

In the GPM, the inter predictor 124 performs an inter prediction based on the sub-regions having been geometrically divided from the current block. On the two sub-regions, the inter predictor 124 performs the inter prediction by using different motion information items (i.e., motion vectors). The inter predictor 124 generates a final predicted signals by weight summing the predicted signals from each region to minimize discontinuities at the boundaries between the sub-regions.

When composing the GPM candidate list, the motion information of each sub-region is derived from a regular merge candidate list. If the index of the merge candidate list is even, the motion information in L0 (the first reference list) is selected, and if the index is odd, the motion information in L1 (the second reference list) is selected.

### I-4. Decoder-side Motion Vector Refinement (DMVR)

Decoder-side Motion Vector Refinement (DMVR) is a method of refining motion vectors at the decoder side by fine-tuning the motion vectors (MV0 and MV1) in the bi-prediction by using the bilateral matching (BM) technique. Hereinafter, the motion vectors in the bi-prediction are used interchangeably with motion vector pairs.

The video decoding apparatus, in the bi-prediction, searches for refined motion vectors neighboring the initial motion vectors generated from the reference pictures in the reference lists L0 and L1. Here, the initial motion vectors are the two motion vectors MV0 and MV1 of the bi-prediction. The BM technique calculates the BM cost, which is the distortion between the two candidate blocks in the reference pictures of L0 and L1. Calculated as the BM cost may be the SAD (sum of absolute differences) or SSE (sum of squared errors) between the two candidate blocks. The video decoding apparatus generates refined motion vectors from the motion vector candidates having the minimum BM cost as shown in Equation 3.

$$MV\_ {0}^{′} = MV\_ 0 + MVoffset \qquad [ Equation 3 ]$$

$$MV\_ {1}^{′} = MV\_ 1 - MVoffset$$

Here, MVoffset is an offset applied to the initial motion vectors as motion vector refinement progresses, and it is the difference between the candidate motion vectors and the initial motion vectors. This offset may be formed as the sum of an integer offset in integer sample units, and a sub-pixel offset in sub-pixel or sub-pel sample units. As shown in Equation 3, the candidates for the two motion vectors follow a mirroring rule for the offsets.

### I-5. Subblock-Based Temporal Motion Vector Prediction (SbTMVP)

Similar to the above-described temporal merge candidate, SbTMVP utilizes motion information within a co-located picture to improve the motion vector prediction of each subblock in merge mode. Each subblock is one of the blocks generated by splitting the current block, and a co-located picture represents the picture containing the co-located block. Before deriving the motion information of the co-located picture, the SbTMVP applies a motion shift.

The SbTMVP determines, for example, whether pixel A1 illustrated in FIG. 8 has a motion vector that utilizes the co-located picture as a reference picture. If the A1 pixel has a motion vector that utilizes the co-located picture as a reference picture, the motion vector of the A1 pixel is selected as the motion shift. On the other hand, if the A1 pixel does not have a motion vector that utilizes the co-located picture as a reference picture, the motion shift is set to zero.

SbTMVP applies the motion shift to co-located blocks within the co-located picture. For each subblock, the SbTMVP extracts motion information (motion vector and reference indices) of the corresponding subblock in the co-located picture. The SbTMVP applies temporal motion scaling to the extracted motion information to generate motion information for each subblock.

The following embodiments are described with reference to the video decoding apparatus, but may be implemented in the same or similar manner in the video encoding apparatus.

### II. Embodiments According to the Present Disclosure

FIG. 9 is a detailed block diagram of a portion of the video decoding apparatus, according to at least one embodiment of the present disclosure.

The video decoding apparatus according to some embodiments can determine prediction and transform units, and in response to a current block corresponding to the determined unit, perform a prediction and an inverse transform by using a determined prediction technique and prediction mode, to finally generate a reconstructed block of the current block. The operations illustrated in FIG. 9 may be performed by the inverse transformer 530, the predictor 540, and the adder 550 of the video decoding apparatus. On the other hand, the same operations as illustrated in FIG. 9 may be performed by the inverse transformer 165, the picture splitter 110, the predictor 120, and the adder 170 of the video encoding apparatus. In this case, the video decoding apparatus uses encoding information parsed from the bitstream, but the video encoding apparatus may use encoding information set from a higher level in terms of minimizing rate distortion. Hereinafter, for convenience, the embodiments are described centering on the video decoding apparatus.

As illustrated in FIG. 5, the predictor 540 includes the intra predictor 542 and the inter predictor 544, depending on the prediction technique, but as illustrated in FIG. 9, the predictor 540 may include all or part of a prediction unit-determiner 902, a prediction technique-determiner 904, a prediction mode-determiner 906, and a prediction performer 908.

If the color format of the input video is a YUV format (YUV420, YUV411, YUV422, YUV444, and the like), the video decoding apparatus may perform prediction and reconstruction of the luma component, and then perform prediction and reconstruction of the chroma component. In this way, the luma component and the chroma component may be sequentially reconstructed by the components illustrated in FIG. 9. On the other hand, if the color format of the input video is RGB, the video encoding apparatus may perform a color format conversion from RGB to YUV, and then encode the converted video. Here, in the YUV format, the color format represents a correspondence between pixels in the luma component and pixels in the chroma component.

The prediction unit-determiner 902 determines a prediction unit (PU). The prediction technique-determiner 904, with respect to the prediction unit, determines a prediction technique, e.g., intra prediction, inter prediction, or intra block copy (IBC) mode, palette mode, or the like. The prediction mode-determiner 906 determines a detailed prediction mode for the prediction technique. The prediction performer 908 generates a prediction block of the current block according to the determined prediction mode.

The inverse transformer 530 includes a transform unit-determiner 910 and an inverse transform-performer 912. The transform unit-determiner 910 determines a transform unit (TU) in response to the dequantized signals of the current block, and the inverse transform-performer 912 inversely transforms the transform unit represented by the dequantized signals to generate residual signals.

The adder 550 sums the prediction block and the residual signals to generate a reconstructed block. The reconstructed block is stored in memory and may be used for predicting other blocks in the future.

The prediction unit determined by the prediction unit-determiner 902 may become the current block or one subblock of the subblocks split from the current block. In this case, the prediction unit of the chroma component may correspond in size to the prediction unit of the luma component, depending on the color format. Alternatively, the prediction units of the luma component and the chroma component may be determined separately, and the prediction may be performed with respect to the prediction unit of the chroma component.

The prediction technique-determiner 904 determines a prediction technique for the prediction units. As described above, the prediction technique may be one of inter prediction, intra prediction, IBC mode, and palette mode. In this case, the prediction technique for the chroma component may be determined to be the same as the prediction technique of the corresponding luma component without signaling and parsing any additional information.

In one example, if the prediction technique of the current block is not intra prediction, the video decoding apparatus parses the 1-bit flag information. If the parsed flag indicates a skip mode, the video decoding apparatus may determine the prediction mode of the current block to be an inter prediction merge mode or an IBC merge mode. The video decoding apparatus may also use the prediction signals as reconstructed signals, skipping an inverse transform.

On the other hand, if the parsed flag does not indicate a skip mode with respect to the current block, the prediction technique-determiner 904 may determine one of the prediction techniques, such as inter prediction, intra prediction, IBC mode, palette mode, or the like, by parsing a series of 1-bit flags to be the prediction technique of the current block.

For example, if skip mode is not applied to the current block and the inter prediction or IBC mode is determined to be the prediction technique, the video decoding apparatus parses a 1-bit flag. The video decoding apparatus may determine, based on the parsed flag, the prediction mode of the current block to be merge mode or AMVP (advanced motion vector prediction) mode.

The prediction mode-determiner 906 determines a detailed prediction mode for the prediction technique.

As an example, when the prediction mode of the current block is merge mode or skip mode, the prediction mode-determiner 906 may by use parsing of a one-bit flag to determine whether to perform subblock-based prediction. If subblock-based prediction is to be performed, affine prediction or SbTMVP prediction may be performed. If subblock-based prediction is not to be performed, prediction may be performed according to techniques such as regular merge mode, MMVD, DMVR, GPM, and the like.

The prediction performer 908 generates a prediction block of the current block according to the determined prediction technique and prediction mode.

As an example, when the prediction technique of the current block is inter prediction and the prediction mode is merge mode or skip mode, the prediction performer 908 parses the merge index and composes a motion vector candidate list. The prediction performer 908 reorders the motion vector candidates in the motion vector candidate list, and uses the merge index to obtain the motion information of the current block from the reordered motion vector candidates' list. The prediction performer 908 uses the motion information to generate the final prediction signals of the current block.

After parsing the merge index, the video decoding apparatus composes the motion vector candidate list of the current block according to the above-described method of composing the merge candidate list of the motion information in the regular merge/skip mode. The motion vector candidate list includes a preset number of (e.g., n) motion vector candidates. Hereinafter, the motion vector candidate list and the merge candidate list are used interchangeably. Motion vector candidates and merge candidates are used interchangeably. A motion vector candidate may be a uni-directional motion vector or bi-directional motion vectors.

Upon composing the motion vector candidate list, the video decoding apparatus performs initial motion refinement on the motion vector candidates included in the motion vector candidate list.

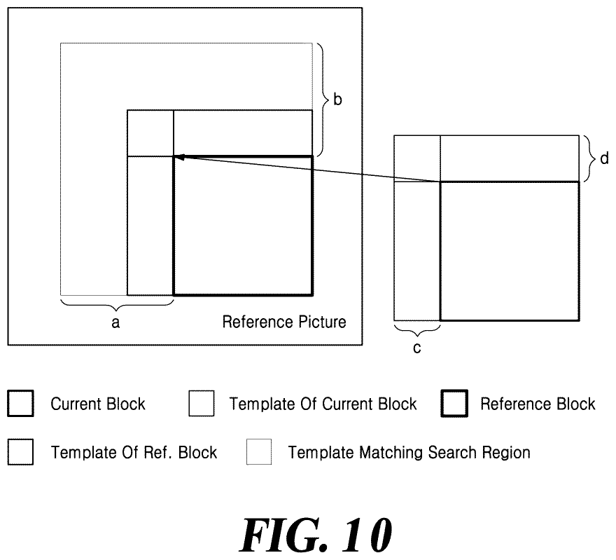

FIG. 10 is a diagram illustrating a motion vector refinement using template matching, according to at least one embodiment of the present disclosure.

In one example, when the prediction method of the current block is not a subblock-based prediction method, the video decoding apparatus refines a uni-directional motion vector among the motion vector candidates by using template matching, as illustrated in FIG. 10. The video decoding apparatus refines the uni-directional motion vector by using template matching between a template in a reconstructed region neighboring the current block and a template at a corresponding location neighboring a reference block. Here, the reference block is indicated by the above-described uni-directional motion vector.

Hereinafter, the template in the reconstructed region neighboring the current block is used interchangeably with the ‘template of the current block’. The template of the corresponding location neighboring the reference block is used interchangeably with the ‘corresponding template of the reference block’. The region covered by the template of the current block is denoted by the template region of the current block. The region covered by the corresponding template of the reference block is denoted by the corresponding template region of the reference block.

To calculate a template matching cost between the samples in the template region of the current block and the samples in the corresponding template region of the reference block, the video decoding apparatus may use one of a number of measures, such as the sum of absolute differences (SAD), the mean squared error (MSE), the sum of absolute transform differences (SATD), or the like.

The video decoding apparatus performs template matching by using templates within a template matching search region defined by ‘a’ and ‘b’, as illustrated in FIG. 10. The template matching search region may be adaptively determined based on a size, aspect ratio, and the like of the current block. The video decoding apparatus may so refine the uni-directional motion vector as to minimize the template matching cost within the template matching search region.

The template matching search region exists within a reference picture. Hereinafter, the template matching search region is used interchangeably with a search region. The corresponding template of the reference block is present within the search region.

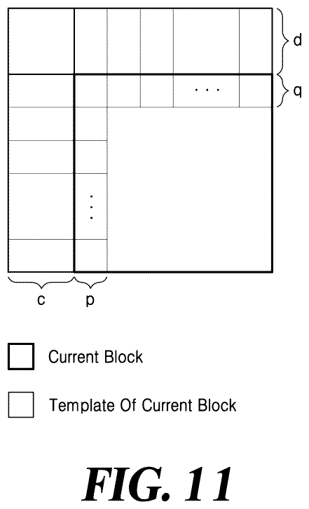

As another example, when the prediction method of the current block is a subblock-based prediction method, the video decoding apparatus uses template matching to refine a uni-directional motion vector among motion vector candidates. For subblocks of size p×q at the top and left of the current block, as in the example of FIG. 11, the video decoding apparatus refines the uni-directional motion vector by using template matching between templates adjacent to each subblock and templates at corresponding locations neighboring the reference subblock.

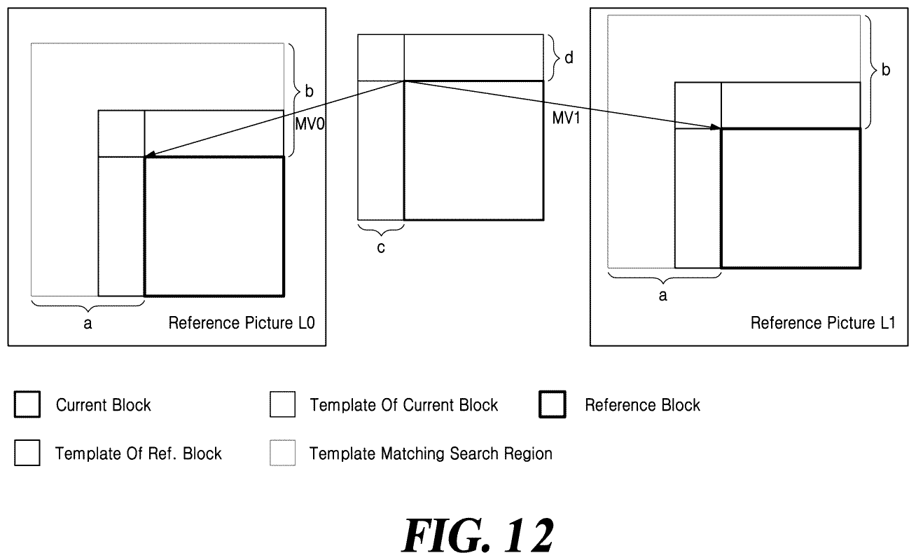

FIG. 12 is a diagram illustrating a motion vector refinement using template matching, according to another embodiment of the present disclosure.

In one example, when the prediction method of the current block is not a subblock-based prediction method, the video decoding apparatus refines the bi-directional motion vectors among the motion vector candidates by using template matching, as illustrated in FIG. 12. The video decoding apparatus refines the bi-directional motion vectors (MV0 and MV1) by using template matching between templates in the reconstructed region neighboring the current block and templates at corresponding locations neighboring the reference blocks. Alternatively, the video decoding apparatus may refine the bi-directional motion vectors by using bilateral matching (BM) between the reference blocks. Here, the reference blocks in the reference pictures in both directions (L0 reference picture and L1 reference picture) are indicated by the above-described bi-directional motion vectors.

In one example, if the motion vector candidate is bi-directional motion vectors, the video decoding apparatus may refine the bi-directional motion vectors by using template matching, and then use BM between reference blocks to apply secondary refinement to the primarily refined bi-directional motion vectors.

At this point, to calculate the template matching cost between samples in the template region of the current block and samples in the corresponding template region of the reference block, the video decoding apparatus may use one of the measures such as SAD, MSE, SATD, or the like.

The video decoding apparatus performs template matching by using templates in a template matching search region defined by ‘a’ and ‘b’, as illustrated in FIG. 12. At this time, the template matching search region may be adaptively determined based on a size, aspect ratio, and the like of the current block. The video decoding apparatus may so refine the bi-directional motion vectors within the template matching search region as to minimize the template matching cost.

The video decoding apparatus may use one of a number of measures, such as SAD, MSE, SATD, or the like, to calculate a BM cost between a reference block in reference picture L0 and a reference block in reference picture L1.

In one example, when the prediction method for the current block is a subblock-based prediction method, the video decoding apparatus refines the bi-directional motion vectors among the motion vector candidates by using template matching. For subblocks of size p×q at the top and left of the current block, as illustrated in FIG. 11, the video decoding apparatus refines the bi-directional motion vectors by using template matching between templates adjacent to each subblock and templates at corresponding locations neighboring the reference subblock.

As another example, when the prediction method for the current block is a subblock-based prediction method, the video decoding apparatus refines the motion information of the bi-directional motion vectors by using the BM. Here, the motion information may be the initial motion information or the motion information after being primarily refined according to a non-BM method. For subblocks of size p×q at the top and left of the current block, the video decoding apparatus may perform BM by comparing each subblock with reference subblocks at corresponding locations, as illustrated in FIG. 11.

As yet another example, the video decoding apparatus may omit the initial motion refinement.

After performing the initial motion refinement, the video decoding apparatus reorders the motion vector candidates in the motion vector candidate list. Alternatively, when omitting the initial motion refinement, the video decoding apparatus may reorder the motion vector candidates before the initial motion refinement.

In one example, the video decoding apparatus generates a reference block based on the motion information of each motion vector candidate and then calculates a template matching cost between a template of the current block and a corresponding template in the reference block. The video decoding apparatus compares the template matching costs of the motion vector candidates. The video decoding apparatus reorders the motion vector candidates in the motion vector candidate list in order of increasing template matching cost. In doing so, the video decoding apparatus may use one of the measures, such as SAD, MSE, SATD, or the like, to calculate the template matching cost between the samples in the template region of the current block and the samples in the corresponding template region of the reference block.

As another example, the video decoding apparatus may omit reordering of the motion vector candidates.

In one example, the video decoding apparatus performs template matching within a search region. The search region may be adaptively determined based on the size, aspect ratio, and the like of the current block.

In one example, for the corresponding templates of the two reference blocks obtained from the bi-directional motion vectors among the motion vector candidates, the video decoding apparatus calculates a template matching cost between the template of the current block and the corresponding template of each reference block, and then averages the two template matching cost values to calculate a final template matching cost for the aforementioned motion vector candidate.

The video decoding apparatus uses the merge index to select the motion vector of the current block from the motion vector candidates in the reordered motion vector candidate list. Alternatively, when omitting the reordering of the motion vector candidates, the video decoding apparatus uses the merge index to select the motion vector of the current block from the motion vector candidates in the motion vector candidate list before reordering.

When bi-directional motion vectors are selected according to the merge index, the video decoding apparatus performs a final motion refinement by using the reference blocks obtained by using the bi-directional motion vectors (MV0 and MV1). The video decoding apparatus may perform the final motion refinement by performing subblock-based BM and/or Bi-directional Optical Flow (BDOF). BDOF further compensates for the motion of samples predicted by using bi-directional motion prediction based on optical flow under the assumption that the samples or objects that constitute the video are moving at a constant speed and that there is little variation in sample values.

The video decoding apparatus performs motion compensation of the current block by using the motion vector with the final motion refinement applied or using the motion vector selected according to the merge index, and thereby generates a final prediction block of the current block. The video decoding apparatus then decodes the residual block, and sums the final prediction block and the residual block to generate a reconstructed block of the current block.

When performing template matching-based motion refinement or template matching-based motion vector candidate reordering on the motion vector candidates of the current block, the video decoding apparatus performs the following process. In some embodiments, the following process is applicable when the prediction method of the current block is not a subblock-based prediction method.

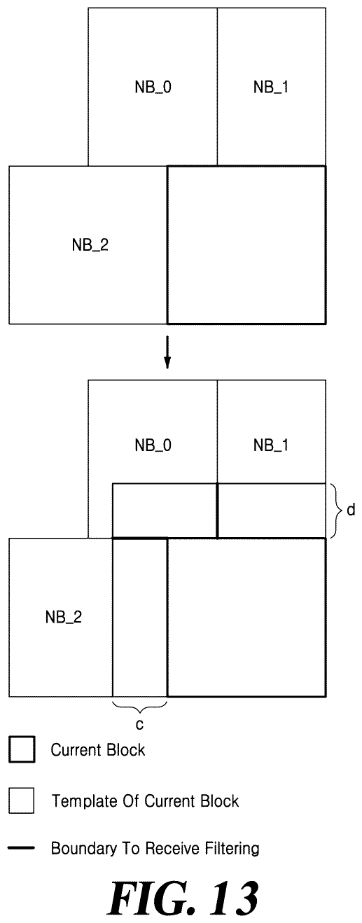

FIG. 13 is a diagram illustrating filtering on a template region, according to one embodiment of the present disclosure.

In one example, before performing template matching, the video decoding apparatus may perform filtering on the reconstructed template region neighboring the current block, i.e., on the template region of the current block. For example, as shown in the top illustration of FIG. 13, the following describes the current block's template region that is block-split. The video decoding apparatus may perform filtering at partition boundaries within the template region, as shown in the bottom illustration of FIG. 13.

In one example, if the boundary receiving the filtering is a horizontal boundary, the video decoding apparatus applies filtering to the template region (TM(i,j)) of the current block in a vertical direction as shown in Equation 4.

$$TM ( i , j ) = {\sum }_{j} f ( j ) \times TM ( i , j ) \qquad [ Equation 4 ]$$

Further, if the boundary receiving the filtering is a vertical boundary, the video decoding apparatus applies the filtering in a horizontal direction to the template region (TM(i,j)) of the current block, as shown in Equation 5.

$$TM ( i , j ) = {\sum }_{i} f ( i ) \times TM ( i , j ) \qquad [ Equation 5 ]$$

In Equation 4 or Equation 5, the filter f(k) may be a smoothing filter with coefficients of {¼, ½, ¼}.

As another example, the video decoding apparatus applies a filter to the template region (TM(i, j)) of the current block as shown in Equation 6.

$$TM ( i , j ) = M ( i , j ) \times TM ( i , j ) \qquad [ Equation 6 ]$$

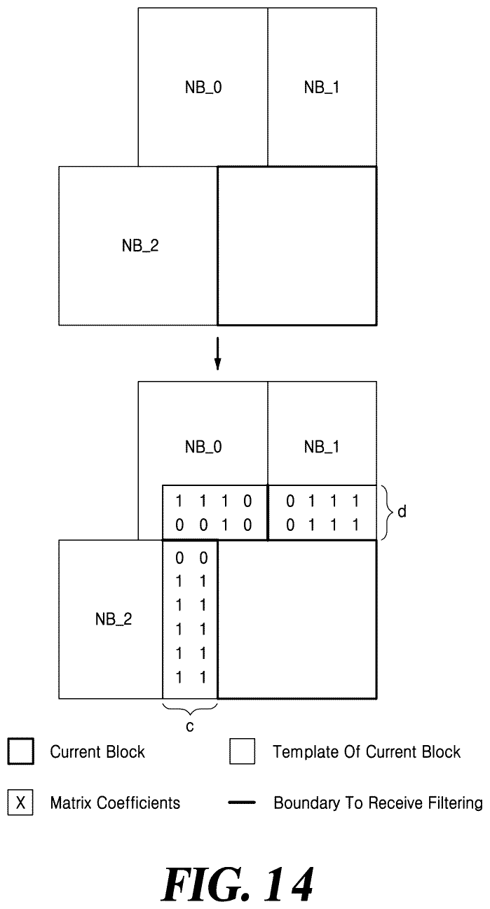

In Equation 6, M(i,j) denotes a matrix that performs the per-pixel operation. As shown in the bottom illustration of FIG. 14, M(i,j) may have a value of 0 at locations around the partition boundaries within the template region of the current block and a value of 1 at the remaining locations within the template region of the current block.

Further, when M(i,j) is configured as in the bottom illustration of FIG. 14, on the corresponding template TM_{ref}(i,j) of the reference block for template matching, the video decoding apparatus may perform filtering as shown in Equation 6.

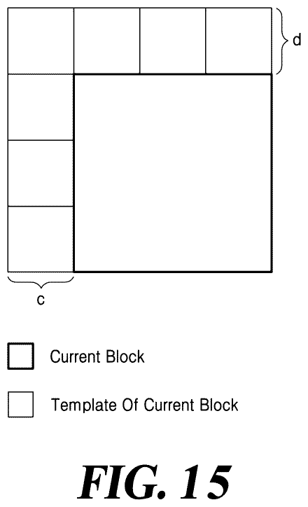

In one example, for the template region of the current block, the video decoding apparatus may partition the template region into sub-regions having a size of c×d, as illustrated in FIG. 15, and then may perform filtering on the boundaries between the sub-regions. In this case, c and d may be adaptively determined based on the size, aspect ratio, and the like of the current block.

For example, if the difference between neighboring samples along a boundary of each sub-region is greater than a preset threshold, the video decoding apparatus may apply filtering according to Equation 4 or Equation 5 to the boundary. The video decoding apparatus may calculate the difference between neighboring samples by using one of the measures such as SAD, MSE, or the like. The threshold may be a predetermined value based on an agreement between the video encoding apparatus and the video decoding apparatus. Alternatively, the threshold may be an average value of the samples in the template region of the current block.

In one example, by using the filtered template region TM(i,j) of the current block and the filtered corresponding template region TM_{ref}(i,j) of the reference block, the video decoding apparatus calculates a template matching cost TM_{cost} according to Equation 7. The video decoding apparatus may calculate the template matching cost by using one of the measures such as SAD, MSE, or the like.

$${TM}_{cost} = {\sum }_{i , j} \vert TM ( i , j ) - {TM}_{r e f} ( i , j ) \vert \qquad [ Equation 7 ]$$

As another example, for the template region of the current block, the video decoding apparatus may calculate a template matching cost according to Equation 8 or Equation 9. Because the filtering is applied in Equation 8 or Equation 9, the filtering according to Equation 4, Equation 5, and Equation 6 may not be separately applied to the template region TM(i,j) of the current block.

$${TM}_{cost} = {\sum }_{i , j} \vert {\sum }_{k} ( f ( k ) \times TM ( i , j ) ) - {TM}_{ref} ( i , j ) \vert \qquad [ Equation 8 ]$$

$${TM}_{c o s t} = {\sum }_{i , j} \vert M ( i , j ) \times TM ( i , j ) - M ( i , j ) \times {TM}_{ref} ( i , j ) \vert \qquad [ Equation 96 ]$$

In Equation 8, f(k) may be derived according to the same method as the derivation for f(⋅) shown in Equation 4 or Equation 5. Further, in Equation 9, M(i,j) may be derived according to the same method as the derivation of M(i,j) shown in Equation 6.

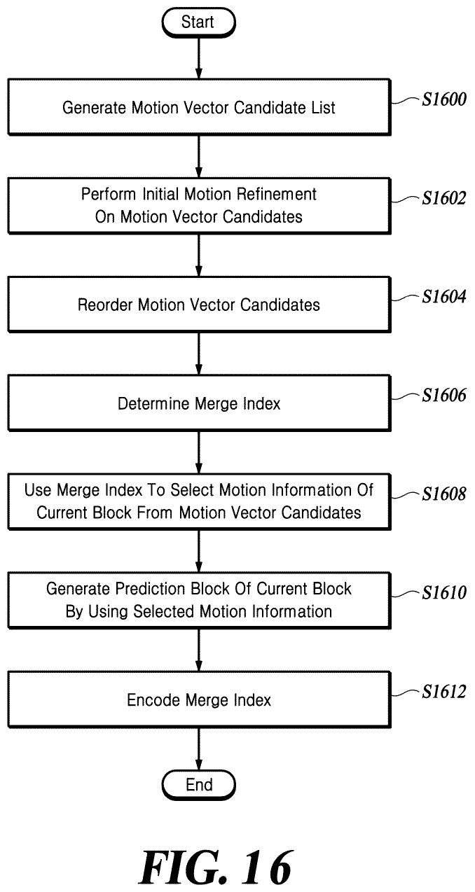

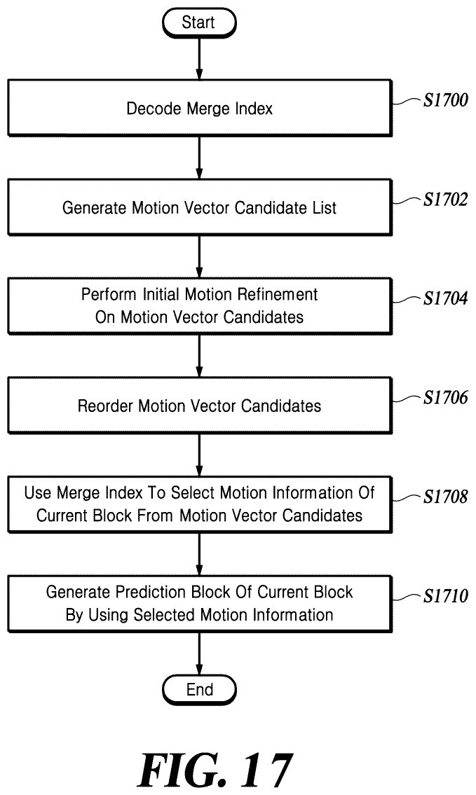

Hereinafter, methods of encoding/reconstructing the current block by using template matching in merge mode are described with reference to FIGS. 16 and 17.

FIG. 16 is a flowchart of a method of encoding the current block by the video encoding apparatus, according to at least one embodiment of the present disclosure.

The video encoding apparatus generates a motion vector candidate list including a preset number of motion vector candidates (S1600). Here, each motion vector candidate may be a uni-directional motion vector or bi-directional motion vectors.

The video encoding apparatus performs initial motion refinement on the motion vector candidates (S1602).

The video encoding apparatus may perform the initial motion refinement by using template matching and/or BM.

The video encoding apparatus performs the initial motion refinement on the current block. The video encoding apparatus refines each motion vector candidate by using template matching between a template of the current block and the corresponding template in a reference block. Alternatively, the video encoding apparatus performs initial motion refinement on the subblocks. In this case, the subblocks may be generated by partitioning the current block. The video encoding apparatus refines each motion vector candidate by using template matching between templates adjacent to each subblock and corresponding templates in the reference subblock.

The video encoding apparatus may omit the initial motion refinement.

When using template matching to perform the initial motion refinement, the video encoding apparatus may apply filtering to block partition boundaries within the template region of the current block.

The video encoding apparatus reorders the motion vector candidates (S1604).

The video encoding apparatus may generate a reference block based on the motion information of each motion vector candidate, and then calculate a template matching cost between the template of the current block and the corresponding template of the reference block. The video encoding apparatus compares the template matching costs of the motion vector candidates. The video encoding apparatus reorders the motion vector candidates in the merge candidate list in order of increasing template matching cost.

The video encoding apparatus may omit reordering the motion vector candidates.

When using template matching to reorder the motion vector candidates, the video encoding apparatus may apply filtering to the block partition boundaries within the template region of the current block.

The video encoding apparatus determines a merge index that indicates one of the motion vector candidates (S1606). In terms of rate distortion optimization, the video encoding apparatus may determine the merge index.

The video encoding apparatus uses the merge index to select the motion information of the current block from the motion vector candidates (S1608).

When the motion information of the current block is a set of bi-directional motion vectors, the video encoding apparatus may perform the final refinement of the bi-directional motion vectors by using at least one of subblock-based bi-directional matching or BDOF.

The video encoding apparatus generates a prediction block of the current block by using the selected motion information (S1610).

The video encoding apparatus encodes the merge index (S1612).

The video encoding apparatus then subtracts the prediction block from the original block of the current block to generate a residual block. The video encoding apparatus transforms/quantizes/encodes the residual block to generate a bitstream, and transmits the generated bitstream to the video decoding apparatus.

FIG. 17 is a flowchart of a method of reconstructing the current block by the video decoding apparatus, according to at least one embodiment of the present disclosure.

The video decoding apparatus decodes the merge index of the current block from the bitstream (1700).

The video decoding apparatus generates a motion vector candidate list including a preset number of motion vector candidates (1702). Here, each motion vector candidate may be a uni-directional motion vector or bi-directional motion vectors.

The video decoding apparatus performs an initial motion refinement on the motion vector candidates (1704).

The video decoding apparatus may perform the initial motion refinement by using template matching and/or BM.

The video decoding apparatus performs the initial motion refinement on the current block. The video decoding apparatus refines each motion vector candidate by using template matching between a template of the current block and the corresponding template in a reference block. Alternatively, the video decoding apparatus performs initial motion refinement on the subblocks. In this case, the subblocks may be generated by partitioning the current block. The video decoding apparatus refines each motion vector candidate by using template matching between templates adjacent to each subblock and its corresponding template in a reference subblock.

The video decoding apparatus may omit the initial motion refinement.

When using template matching to perform the initial motion refinement, the video decoding apparatus may apply filtering to block partition boundaries within the template region of the current block.

The video decoding apparatus reorders the motion vector candidates (1706).

The video decoding apparatus generates a reference block based on the motion information of each motion vector candidate, and then calculates a template matching cost between the template of the current block and the corresponding template of the reference block. The video decoding apparatus compares the template matching costs of the motion vector candidates. The video decoding apparatus reorders the motion vector candidates in the merge candidate list in order of increasing template matching cost.

The video decoding apparatus may omit reordering the motion vector candidates.

When using template matching to reorder the motion vector candidates, the video decoding apparatus may apply filtering to the block partition boundaries within the template region of the current block.

The video decoding apparatus uses a merge index to select motion information of the current block from the motion vector candidates (1708).

When the motion information of the current block is a set of bi-directional motion vectors, the video decoding apparatus performs the final refinement of the bi-directional motion vectors by using at least one of subblock-based bi-directional matching or BDOF.

The video decoding apparatus generates a prediction block of the current block by using the selected motion information (1710).

The video decoding apparatus decodes/dequantizes/inversely transforms the bitstream to generate a residual block. The video decoding apparatus then sums the prediction block and the residual block to generate a reconstructed block of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

124: inter predictor
544: inter predictor
902: prediction unit-determiner
904: prediction technique-determiner
906: prediction mode-determiner
908: prediction performer

1. A method of reconstructing a current block by a video decoding apparatus, the method comprising:
decoding a merge index of the current block from a bitstream;
generating a motion vector candidate list of the current block, wherein the motion vector candidate list includes a preset number of motion vector candidates, and a motion vector candidate is a uni-directional motion vector or bi-directional motion vectors;
performing an initial motion refinement on the motion vector candidates;
reordering the motion vector candidates;
selecting motion information of the current block from the motion vector candidates by using the merge index; and
generating a prediction block of the current block by using a selected motion information,
wherein performing the initial motion refinement or reordering the motion vector candidates comprises, when using a template matching:
applying filtering to block partition boundaries within a template region of the current block.

2. The method of claim 1, further comprising, when the motion information of the current block is the bi-directional motion vectors:
finally refining the bi-directional motion vectors by using at least one technique of a subblock-based bilateral matching or a bi-directional optical flow (BDOF).

3. The method of claim 1, wherein performing the initial motion refinement comprises, when the motion vector candidate is the uni-directional motion vector:
deriving a reference block indicated by the uni-directional motion vector, and refining the uni-directional motion vector by using a template matching between a template of the current block and a corresponding template of the reference block.

4. The method of claim 3, wherein performing the initial motion refinement comprises:
determining, based on a size or aspect ratio of the current block, a search region within a reference picture that includes the reference block; and
performing the template matching within the search region.

5. The method of claim 3, wherein the template of the current block represents a template within a reconstructed region neighboring the current block, and the corresponding template of the reference block represents a template at a corresponding location neighboring the reference block.

6. The method of claim 1, wherein performing the initial motion refinement comprises, when the motion vector candidate is the bi-directional motion vectors:
deriving reference blocks indicated by the bi-directional motion vectors, and refining the bi-directional motion vectors by using a template matching between a template of the current block and corresponding templates of the reference blocks.

7. The method of claim 1, wherein performing the initial motion refinement comprises, when the motion vector candidate is the bi-directional motion vectors:
deriving reference blocks indicated by the bi-directional motion vectors, refining the bi-directional motion vectors by using a template matching between a template of the current block and corresponding templates of the reference blocks, and refining the refined bi-directional motion vectors a second time by using a bilateral matching between the reference blocks.

8. The method of claim 1, wherein reordering the motion vector candidates comprises:
generating a reference block according to motion information of the motion vector candidate;
generating a template matching cost between a template of the current block and a corresponding template of the reference block; and
reordering the motion vector candidates in an order of increasing template matching costs of the motion vector candidates.

9. The method of claim 8, wherein generating the template matching cost comprises, when the motion vector candidate is the bi-directional motion vectors:
with respect to reference blocks indicated by the bi-directional motion vectors, calculating a template matching cost between the template of the current block and a corresponding template of each of the reference blocks, and calculating a template matching cost of the motion vector candidate by averaging template matching costs of the reference blocks.

10. The method of claim 1, wherein applying the filtering to the block partition boundaries comprises:
filtering a template region of the current block in a vertical direction when the block partition boundaries are horizontal boundaries, and filtering the template region of the current block in a horizontal direction when the block partition boundaries are vertical boundaries.

11. The method of claim 10, wherein performing the initial motion refinement or the reordering of the motion vector candidates comprises:
generating a reference block based on motion information of the motion vector candidate; and
calculating a template matching cost between a filtered template region of the current block and a corresponding template region of the reference block.

12. The method of claim 1, wherein applying the filtering to the block partition boundaries comprises:
multiplying the template region of the current block by a matrix performing a pixel-by-pixel operation, wherein the matrix has a value of 0 at neighboring locations of the block partition boundaries and a value of 1 at remaining locations within the template region of the current block.

13. The method of claim 12, wherein performing the initial motion refinement or the reordering of the motion vector candidates comprises:
generating a reference block based on motion information of the motion vector candidate;
multiplying a corresponding template region of the reference block by the matrix; and
calculating a template matching cost between the template region of the current block, multiplied by the matrix and the corresponding template region of the reference block, multiplied by the matrix.

14. A method of encoding a current block by a video encoding apparatus, the method comprising:
generating a motion vector candidate list of the current block, wherein the motion vector candidate list includes a preset number of motion vector candidates, and a motion vector candidate is a uni-directional motion vector or bi-directional motion vectors;
performing an initial motion refinement on the motion vector candidates;
reordering the motion vector candidates;
determining a merge index indicative of one of the motion vector candidates;
selecting motion information of the current block from the motion vector candidates by using the merge index; and
generating a prediction block of the current block by using a selected motion information,
wherein performing the initial motion refinement or reordering the motion vector candidates comprises, when using a template matching:
applying filtering to block partition boundaries within a template region of the current block.

15. The method of claim 14, further comprising:
encoding the merge index.

16. The method of claim 14, further comprising, when the motion information of the current block is the bi-directional motion vectors:
finally refining the bi-directional motion vectors by using at least one technique of a subblock-based bilateral matching or a bi-directional optical flow (BDOF).

17. A computer-readable recording medium storing a bitstream generated by a video encoding method, the video encoding method comprises:
generating a motion vector candidate list of a current block, wherein the motion vector candidate list includes a preset number of motion vector candidates, and a motion vector candidate is a uni-directional motion vector or bi-directional motion vectors;
performing an initial motion refinement on the motion vector candidates;
reordering the motion vector candidates;
determining a merge index indicative of one of the motion vector candidates;
selecting motion information of the current block from the motion vector candidates by using the merge index; and
generating a prediction block of the current block by using a selected motion information,
wherein performing the initial motion refinement or reordering the motion vector candidates comprises, when using a template matching:
applying filtering to block partition boundaries within a template region of the current block.
